(19) United States
(12) Patent Application Publication
(10) Pub. No.: US 2009/0141177 A1
(43) Pub. Date: Jun. 4, 2009

(54) AUTOMATIC GAIN CONTROL CIRCUIT USING GAIN SHIFT

(75) Inventor: YUM-CHENG CHANG, Mission Viejo, CA (US)

Correspondence Address: PCE INDUSTRY, INC.;ATT. Steven Reiss, 458 E. LAMBERT ROAD, FULLERTON, CA, 92835, US

(73) Assignee: FITIPOWER INTEGRATED TECHNOLOGY, INC., Hsinchu (TW)

(21) Appl. No.: 12/182,350

(22) Filed: Jul. 30, 2008

(30) Foreign Application Priority Data
Nov. 29, 2007 (CN) 200710195815.X

(51) Int. Cl. H04N 5/52

(52) U.S. Cl. 348/678

(57) ABSTRACT

An AGC circuit includes a RF amplifying module has a first gain control resolution, a frequency converter, an IF/Baseband amplifying module has a second gain control resolution, an IF/Baseband micro-setting amplifying module has a third gain control resolution which is higher than the first and the second, an A/D converter, an AGC module and a gain distribution module. The AGC module is configured for detecting a level of a digital IF/Baseband signal outputted from A/D converter, comparing the detected level with a reference level and generating a digital AGC signal and a digital gain distribution control signal based upon the comparison result. The gain distribution module is subjected to the control of digital AGC signal and digital gain distribution control signal and configured for generating digital gain control signals to selectively adjust the gains of RF amplifying module, IF/Baseband amplifying module and IF/Baseband micro-setting amplifying module.

### CROSS-REFERENCE TO RELATED APPLICATIONS

This application claims all benefits accruing under 35 U.S.C. §119 from China Patent Application No. 200710195815.X, filed on Nov. 29, 2007 in the China Intellectual Property Office, the disclosure of which is incorporated herein by reference.

This application is related to a co-pending application entitled a same title with the present application (attorney docket number US15046), assigned to the same assignee of this application and filed on the same date. The disclosure of the co-pending application is wholly incorporated herein by reference.

### BACKGROUND

1. Technical Field

The present invention generally relates to automatic gain control circuits, and particularly to an automatic gain control circuit used in digital television receivers.

2. Description of Related Art

Digital televisions have the advantages of higher definition (or higher resolution) and compact disc (CD) level multi-channel audio output as compared to traditional analog televisions. Nowadays, various countries such as United States, Europe and Japan have already established their own digital television broadcast formats, e.g., vestigial sideband (“VSB”) for the United States. The detailed information with respect to the VSB broadcast format has been published in a paper by Wayne et al. on IEEE Transactions on Consumer Electronics, vol. 41, No. 3 (August 1995), entitled “VSB Modem Subsystem Design for Grand Alliance Digital Television Receivers”, the disclosure of which is incorporated herein by reference.

A typical digital television receiver primarily includes an antenna for receiving radio frequency (RF) signals (i.e., generally high frequency signals), a tuner for channel select, an automatic gain control circuit and a demodulator. The automatic gain control circuit generally includes a RF amplifier, a frequency converter, an Intermediate Frequency(IF)/Baseband amplifier, and an analog-to-digital (A/D) converter and an automatic gain controller. The RF amplifier is for amplifying an RF signal of the selected channel. The frequency converter is for converting the selected RF signal into an IF signal or baseband (zero-IF) signal. The IF/Baseband amplifier is for amplifying the IF/Baseband signal. The A/D converter is for converting the amplified IF/Baseband signal into a digital IF/Baseband signal. The digital IF/Baseband signal is outputted to the demodulator, for demodulation, as well as the automatic gain controller. The automatic gain controller receives the digital IF/Baseband signal, compares the digital IF/Baseband signal with a reference level and then generates gain control signals in analog form to independently control gains of the RF amplifier and the IF/Baseband amplifier, so as to regulate the signal outputted from the IF/Baseband amplifier at a desired level.

During the process for controlling gains of the RF signal and the IF/Baseband signal by the automatic gain control circuit, the automatic gain control circuit has large range for gain control. But the resolution of gain control (namely a minimum adjustable value for the gain control) impacts, to a large extent, effect the quality of the gain control. Improving the resolution of gain control involves complex circuitry and high cost of manufacturing.

Therefore, what is needed is an automatic gain control circuit with high gain control resolution and has a simple circuit structure.

### SUMMARY

An automatic gain control (AGC) circuit in accordance with a present embodiment is provided. The AGC circuit includes a RF amplifying module with an adjustable gain and a first gain control resolution, a frequency converter, an IF/Baseband amplifying module with an adjustable gain and a second gain control resolution, an IF/Baseband micro-setting amplifying module with an adjustable gain and has a third gain control resolution, an A/D converter, an AGC module and a gain distribution module. The third gain control resolution is higher than the first and second gain control resolutions. The RF amplifying module is configured (i.e., structured and arranged) for amplifying a high frequency signal to be an amplified high frequency signal having the same frequency as the received high frequency signal. The frequency converter is configured for converting the amplified high frequency signal into an IF/Baseband signal. The IF/Baseband amplifying module is configured for amplifying the IF/Baseband signal to be an amplified IF/Baseband signal. The IF/Baseband micro-setting amplifying module is configured for amplifying the amplified IF/Baseband signal to be another IF/Baseband signal having the same frequency as the amplified IF/Baseband signal. The A/D converter is configured for converting the IF/Baseband signal outputted from the IF/Baseband micro-setting amplifying module into a digital IF/Baseband signal. The AGC module is configured for detecting a level of the digital IF/Baseband signal, comparing the detected level with a reference level and generating a digital AGC signal and a digital gain distribution control signal based upon the comparison result. The gain distribution module is subjected to the control of the digital AGC signal and the digital gain distribution control signal and configured for generating digital gain control signals to selectively adjust at least one of the gains of the RF amplifying module, the IF/Baseband amplifying module and the IF/Baseband micro-setting amplifying module in a digital manner to keep the amplified IF/Baseband signal outputted from the IF/Baseband micro-setting amplifying module at a desired level.

Due to the provision of the AGC module and the gain distribution module and corresponding circuit designs for the RF amplifying module, IF/Baseband amplifying module and IF/Baseband micro-setting amplifying module, digital gain control signals can be generated to selectively adjust the gains of the RF amplifying module, the IF/Baseband amplifying module and the IF/Baseband micro-setting amplifying module in a digital manner, and the third gain control resolution is higher than the first and second gain control resolutions. Accordingly, a gain control resolution for the high frequency signal received by the AGC circuit is higher than a typical AGC circuit, and the AGC circuit could have less digital switch circuit result in it has a simple circuit structure. In addition, the gain of the IF/Baseband signal can be accurately adjusted by the IF/Baseband micro-setting amplifying module, and the IF/Baseband signal outputted from the IF/Baseband micro-setting amplifying module can be regulated at a desired level.

Other advantages and novel features will become more apparent from the following detailed description of embodiments, when taken in conjunction with the accompanying drawings.

### BRIEF DESCRIPTION OF THE DRAWINGS

Many aspects of the present AGC circuit can be better understood with reference to the following drawings. The components in the drawings are not necessarily drawn to scale, the emphasis instead being placed upon clearly illustrating the principles of the present AGC circuit. Moreover, in the drawings, like reference numerals designate corresponding parts throughout the several views.

FIG. 1 is a schematic, functional block diagram of an AGC circuit, in accordance with a present embodiment, the AGC circuit including a low noise RF amplifying module and an IF/Baseband amplifying module.

FIG. 2 is a schematic, simplified circuit diagram of a low noise RF amplifying circuit of the low noise RF amplifying module of FIG. 1.

FIG. 3 is a schematic, simplified circuit diagram of an IF/Baseband amplifying circuit of the IF/Baseband amplifying module of FIG. 1.

FIG. 4 is a schematic, simplified circuit diagram of an IF/Baseband micro-setting amplifying circuit of the IF/Baseband amplifying module of FIG. 1.

The exemplifications set out herein illustrate various preferred embodiments, in various forms, and such exemplifications are not to be construed as limiting the scope of the present AGC circuit in any manner.

### DETAILED DESCRIPTION

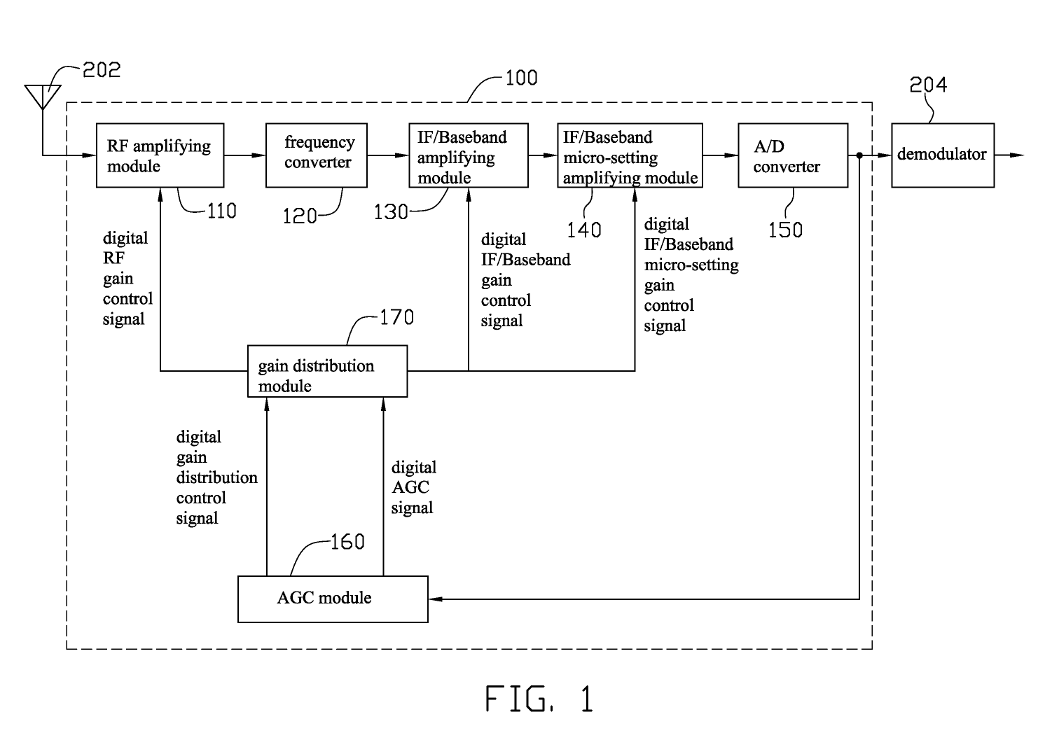

Referring to FIG. 1, an AGC circuit 100 adapted to a digital television receiver, in accordance with a present embodiment, is provided. The AGC circuit 100 includes a RF amplifying module 110, a frequency converter 120, an IF/Baseband amplifying module 130, an IF/Baseband micro-setting amplifying module 140, an A/D converter 150, an AGC module 160 and a gain distribution module 170.

The RF amplifying module 110 has an adjustable gain and a first gain control resolution. The RF amplifying module 110 is configured for amplifying a high frequency signal (such as radio-frequency signal) received from an antenna 202 to be an amplified high frequency signal with same frequency. The RF amplifying module 110 may include one amplifying stage or multiple amplifying stages being coupled in series. Each amplifying stage contains one or a group of low noise RF amplifying circuit(s), and each low noise RF amplifying circuit can be subjected to the control of a digital control signal to change a gain thereof and thereby the gain of the RF amplifying module 110 can be adjusted.

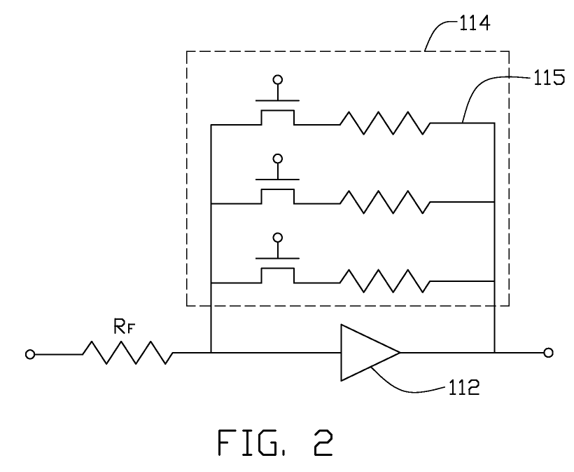

Referring to FIG. 2, a simplified circuit diagram of the low noise RF amplifying circuit is illustrated. The low noise RF amplifying circuit includes an input resistor RF, a low noise RF amplifier 112 and a digital switch circuit 114 coupled in parallel with the low noise RF amplifier 112. The digital switch circuit 114 includes multiple digital switch units 115 being coupled in parallel. Therefore, the gain of the low noise RF amplifying circuit can be changed by a digital control signal selectively controlling the on/off states of the digital switch units 115. It is indicated that the simplified circuit configuration of the low noise RF amplifying circuit in FIG. 2 is only an example for the purpose of illustrating the low noise RF amplifying circuit can be subjected to the control of a digital control signal to change a gain thereof, other suitable circuit configuration also can be employed.

The frequency converter 120 is configured for converting the amplified high frequency signal from the RF amplifying module 110 into an IF/Baseband signal. Typically, the frequency converter 120 includes a local oscillator and a frequency mixer. The IF/Baseband signal can be generated by mixing a signal with local frequency generated from the local oscillator and the amplified high frequency signal.

The IF/Baseband amplifying module 130 has an adjustable gain and a second gain control resolution. The IF/Baseband amplifying module 130 is configured for amplifying the IF/Baseband signal to be an amplified IF/Baseband signal with same frequency. The IF/Baseband amplifying module 130 may include one or multiple amplifying stage(s) being coupled in series. Each amplifying stage contains one or a group of IF/Baseband amplifying circuit(s), and each IF/Baseband amplifying circuit can be subjected to the control of a digital control signal to change a gain thereof and thereby the gain of the IF/Baseband amplifying module 130 can be adjusted.

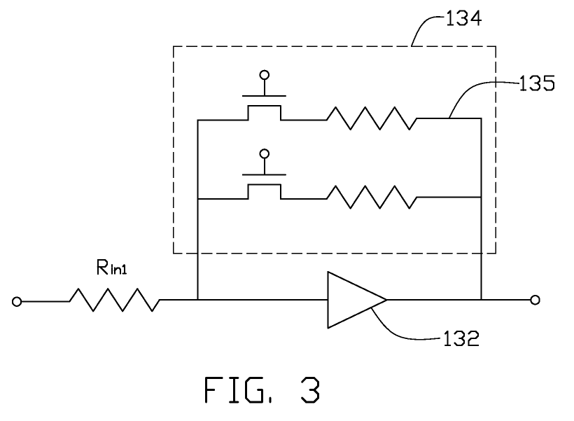

Referring to FIG. 3, a simplified circuit diagram of the IF/Baseband amplifying circuit is illustrated. The IF/Baseband amplifying circuit includes an input resistor Rᵢₙ₁, an IF/Baseband amplifier 132 and a digital switch circuit 134 coupled in parallel with the IF/Baseband amplifier 132. The digital switch circuit 134 includes multiple digital switch units 135 being coupled in parallel. Therefore, the gain of the IF/Baseband amplifying circuit can be changed by a digital control signal selectively controlling the on/off states of the digital switch units 135. It is indicated that the simplified circuit configuration of the IF/Baseband amplifying circuit in FIG. 3 is only an example for the purpose of illustrating that the IF/Baseband amplifying circuit can be controlled by a digital control signal to change a gain thereof, other suitable circuit configuration also can be employed.

The IF/Baseband micro-setting amplifying module 140 has an adjustable gain and a third gain control resolution. The IF/Baseband micro-setting amplifying module 140 is configured for amplifying the amplified IF/Baseband signal outputted from the IF/Baseband amplifying module 130 to be another IF/Baseband signal with same frequency. The third gain control resolution is higher than the second gain control resolution. The IF/Baseband micro-setting amplifying module 140 can include one amplifying stage or multiple amplifying stages being coupled in series. Each amplifying stage contains one or a group of IF/Baseband amplifying circuit(s), and each IF/Baseband amplifying circuit can be subjected to the control of a digital control signal to change a gain thereof and thereby the gain of the IF/Baseband micro-setting amplifying module 140 can be adjusted.

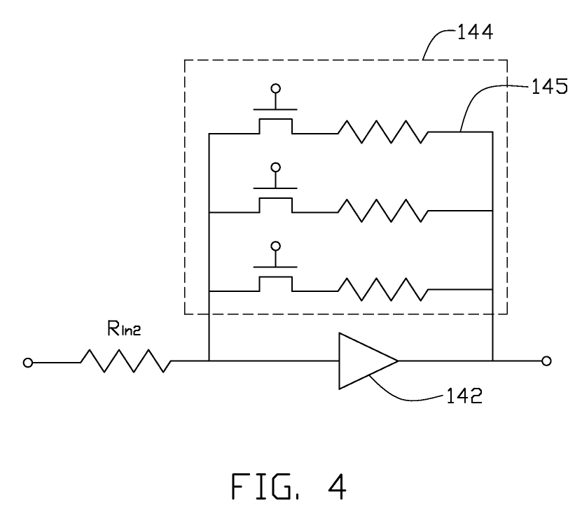

Referring to FIG. 4, a simplified circuit diagram of the IF/Baseband amplifying circuit of the IF/Baseband micro-setting amplifying module 140 is illustrated. The IF/Baseband amplifying circuit includes an input resistor Rᵢₙ₂, an IF/Baseband amplifier 142 and a digital switch circuit 144 coupled in parallel with the IF/Baseband amplifier 142. The digital switch circuit 144 includes multiple digital switch units 145 being coupled in parallel. Therefore, the gain of the IF/Baseband amplifying circuit can be changed by a digital control signal selectively controlling the on/off states of the digital switch units 145. It is indicated that the simplified circuit configuration of the IF/Baseband amplifying circuit in FIG. 4 is only an example for the purpose of illustrating the IF/Baseband amplifying circuit can be subjected to the control of a digital control signal to change a gain thereof, other suitable circuit configuration also can be employed.

The A/D converter 150 is configured for converting the IF/Baseband signal from the IF/Baseband micro-setting amplifying module 140 into a digital IF/Baseband signal. The digital IF/Baseband then is sent to a demodulator 204 as well as the AGC module 160.

The AGC module 160 is configured for detecting a level of the digital IF/Baseband signal, comparing the detected level with a reference level and generating a digital AGC signal and a digital gain distribution control signal based upon the comparison result. The digital AGC signal is used for setting a total gain value of the RF amplifying module 110, the IF/Baseband amplifying module 130 and the IF/Baseband micro-setting amplifying module 140. The digital gain distribution control signal is used for setting gain values distributed to the RF amplifying module 110, the IF/Baseband amplifying module 130 and the IF/Baseband micro-setting amplifying module 140. The digital AGC signal and the digital gain distribution control signal, each may be a pulse width modulation (PWM) signal, a pulse density modulation (PDM) signal, a I2C signals or a general logic signal.

The gain distribution module 170 is subjected to the control of the digital AGC signal and the digital gain distribution control signal, and configured for generating corresponding digital gain control signals to selectively adjust at least one of the gains of the RF amplifying module 110, the IF/Baseband amplifying module 130 and the IF/Baseband micro-setting amplifying module 140, to keep the IF/Baseband signal outputted from the IF/Baseband micro-setting amplifying module 140 at a desired level. The digital gain control signals comprises a digital RF gain control signal, a digital IF/Baseband gain control signal and a digital IF/Baseband micro-setting gain control signal for respectively controlling the gains of the RF amplifying module 110, the IF/Baseband amplifying module 130 and the IF/Baseband micro-setting amplifying module 140.

In particular, the gain distribution module 170 generates corresponding digital gain control signals to selectively adjust the gain values of the RF amplifying module 110, the IF/Baseband amplifying module 130 and the IF/Baseband micro-setting amplifying module 140 respectively equal to G_{RF}, G_{IF}, G_{fine-tune}, based on a total gain value Gₐₗₗof the RF amplifying module 110, the IF/Baseband amplifying module 130 and the IF/Baseband micro-setting amplifying module 140, wherein Gₐₗₗ=G_{RF}+G_{IF}+G_{fine-tune}.

The third gain control resolution is higher than the first and the second gain control resolutions. It can be understood that the first gain control resolution can be identical to or different from the second gain control resolution. As an example for the present embodiment, the first and second gain control resolutions are equal to R₁, the third gain control resolution is equal to R₂, wherein R₂<R₁, namely the third gain control resolution is higher than the first and the second gain control resolutions.

The gain value of the RF amplifying module 110 is equal to G_{RF}, a range of digital control signal for switching the on/off states of the digital switch units 115 is equal to G_{RF}/R₁. The gain value of the IF/Baseband amplifying module 130 is equal to G_{IF}, a range of digital control signal for switching the on/off states of the digital switch units 135 is equal to G_{IF}/R₁. The gain value of the IF/Baseband micro-setting amplifying module 140 is equal to G_{fine-tune}, a range of digital control signal for switching the on/off states of the digital switch units 145 is equal to G_{fine-tune}/R₂. Therefore, a range of digital control signal for the AGC circuit 100 is equal to (G_{RF}/R₁)+(G_{IF}/R₁)+(G_{fine-tune}/R₂).

In contrast, if the AGC circuit does not include the IF/Baseband micro-setting amplifying module 140, the amplified IF/Baseband signal outputted from the IF/Baseband amplifying module 130 can be transmitted into the A/D converter 150. In the case where the same total gain value Gₐₗₗ, the gain value of the RF amplifying module 110 is equal to G_{RF1}, the gain value of the IF/Baseband amplifying module 130 is equal to G_{IF1}, the RF amplifying module 110 and the IF/Baseband amplifying module 130 both have the gain control resolution R₂, wherein Gₐₗₗ=G_{RF1}+G_{IF1}. Therefore, a range of digital control signal for the AGC circuit without the IF/Baseband micro-setting amplifying module 140 is equal to (G_{RF1}/R₂)+(G_{IF1}/R₂). Because of Gₐₗₗ=G_{RF}+G_{IF}+G_{fine-tune}=G_{RF1}+G_{IF1} and R₂<R₁, (G_{RF}/R₁)+(G_{IF}/R₁)+(G_{fine-tune}/R₂) is less than (G_{RF1}/R₂)+(G_{IF1}/R₂). Accordingly, a range of digital control signal for the AGC circuit 100 is less than that for the AGC circuit without the IF/Baseband micro-setting amplifying module 140, so the AGC circuit 100 could have less digital switch circuit 114 results in it has a simple circuit structure. In addition, the third gain control resolution of IF/Baseband micro-setting amplifying module 140 is larger than the first gain control resolution of RF amplifying module 110 and the second gain control resolution of IF/Baseband amplifying module 130, so that a gain control resolution for the high frequency signal received by the AGC circuit 100 is higher than a typical AGC circuit. Therefore, the gain of the IF/Baseband signal can be accurately adjusted by the IF/Baseband micro-setting amplifying module 140, and the IF/Baseband signal outputted from the IF/Baseband micro-setting amplifying module 140 can be regulated at a desired level.

In addition, a person skilled in the art can perform various changes within the spirit of the present embodiment, such as changing the circuit configuration(s) of the RF amplifying module 110, the IF/Baseband amplifying module 130, and/or the IF/Baseband micro-setting amplifying module 140, etc.

It is believed that the present embodiments and their advantages will be understood from the foregoing description and it will be apparent that various changes may be made thereto without departing from the spirit and scope of the invention or sacrificing all of its material advantages, the examples hereinbefore described merely being preferred or exemplary embodiments of the present invention.

What is claimed is:

1. An automatic gain control (AGC) circuit, comprising:
a radio frequency (RF) amplifying module with an adjustable gain and a first gain control resolution, configured for amplifying a received high frequency signal to be an amplified high frequency signal having the same frequency as the received high frequency signal;
a frequency converter configured for converting the amplified high frequency signal into an IF/Baseband signal;
an IF/Baseband amplifying module with an adjustable gain and a second gain control resolution, configured for amplifying the IF/Baseband signal to be an amplified IF/Baseband signal;
an IF/Baseband micro-setting amplifying module with an adjustable gain and a third gain control resolution, configured for amplifying the amplified IF/Baseband signal to be another IF/Baseband signal having the same frequency as the amplified IF/Baseband signal, the third gain control resolution being higher than the first and second gain control resolutions;
an A/D converter configured for converting the IF/Baseband signal outputted from the IF/Baseband micro-setting amplifying module into a digital IF/Baseband signal; and
an AGC module configured for detecting a level of the digital IF/Baseband signal, comparing the detected level with a reference level and generating a digital AGC signal and a digital gain distribution control signal based upon the comparison result; and
a gain distribution module subjected to the control of the digital AGC signal and the digital gain distribution control signal and configured for generating digital gain control signals to selectively adjust at least one of the gains of the RF amplifying module, the IF/Baseband amplifying module and the IF/Baseband micro-setting amplifying module in a digital manner to keep the IF/Baseband signal outputted from the IF/Baseband micro-setting amplifying module at a desired level.

2. The AGC circuit of claim 1, wherein the first gain control resolution is identical to the second gain control resolution.

3. The AGC circuit of claim 1, wherein the RF amplifying module comprises at least one amplifying stage and each of the at least one amplifying stage comprises a digital switch circuit, the digital switch circuit is controlled by a digital RF gain control signal of the digital gain control signals and configured for controlling the gain of the RF amplifying module.

4. The AGC circuit of claim 3, wherein a number of the at least one amplifying stage is multiple, and the multiple amplifying stages coupled in series.

5. The AGC circuit of claim 1, wherein the IF/Baseband amplifying module comprises at least one amplifying stage and each of the at least one amplifying stage comprises a digital switch circuit, the digital switch circuit is controlled by a digital IF/Baseband gain control signal of the digital gain control signals and configured for controlling the gain of the IF/Baseband amplifying module.

6. The AGC circuit of claim 5, wherein a number of the at least one amplifying stage is multiple, and the multiple amplifying stages are coupled in series.

7. The AGC circuit of claim 1, wherein the IF/Baseband micro-setting amplifying module comprises at least one amplifying stage and each of the at least one amplifying stage comprises a digital switch circuit, the digital switch circuit is subjected to the control of a digital IF/Baseband gain control signal of the digital gain control signals and configured for controlling the gain of the IF/Baseband micro-setting amplifying module.

8. The AGC circuit of claim 7, wherein a number of the at least one amplifying stage is multiple, and the multiple amplifying stages are coupled in series.

9. The AGC circuit of claim 1, wherein the digital AGC signal is selected from the group consisting of a pulse width modulation signal, a pulse density modulation signal, an I2C signal and a general logic signal.

10. The AGC circuit of claim 1, wherein the digital gain distribution control signal is selected from the group consisting of a pulse width modulation signal, a pulse density modulation signal, an I2C signal and a general logic signal.
